(19) United States
(12) Patent Application Publication
(10) Pub. No.: US 2013/0068556 A1
(43) Pub. Date: Mar. 21, 2013

(54) Adjustable Harness

(71) Applicant: John D. Price, JR., Baldwinsville, NY (US)

(72) Inventor: John D. Price, JR., Baldwinsville, NY (US)

(73) Assignee: GOLFIRE, INC., Baldwinsville, NY (US)

(21) Appl. No.: 13/421,324

(22) Filed: Mar. 15, 2012

Related U.S. Application Data
(60) Provisional application No. 61/452,847, filed on Mar. 15, 2011.

(51) Int. Cl. A62B 35/00

(52) U.S. Cl. CPC A62B 35/0018
USPC 182/3

(57) ABSTRACT

A safety harness tool has a single web member that is used to form two arm loop structures and two leg loop structures for respectively securing the limbs of a body. The loops are primarily formed by stitched certain portions of the single web member to itself. The arm loops are made to have extra material, beyond what is needed to be securely placed around the arms of the body. When the harness tool is in use, the excess portions of the two arm loops are tied to each other and/or adjusted in size using an adjustment ring, such as a double buckle.

### RELATED APPLICATION

The present application claims priority to U.S. provisional patent application No. 61/452,847, filed on 15 Mar. 2011; all of the foregoing patent-related document(s) are hereby incorporated by reference herein in their respective entirety(ies).

### BACKGROUND OF THE INVENTION

1. Field of the Invention

The present invention relates to a strap tool and, more particularly, to a multi-purpose fully adjustable strap tool, and, even more particularly to a strap support system that can secure a human body to a safety line or rope.

2. Description of the Related Art

Harnesses (that is, strap support systems for securing a human body to a safety line or rope) are an important part of worker safety. Whether it is the result of working at a height, or near dangerous equipment, falls injure thousands of workers every year. Many, if not most, of these falls can be prevented or mitigated by a good harness. Further, safety harnesses can form an important part of rescue attempts when the victim is immobile or otherwise incapable of removing herself from the dangerous situation.

As a result, there is a continued demand for harnesses, both for everyday work and for rescue or emergency situations. It has been recognized that the straps of a harness should preferably be durable, lightweight, comfortable, and easily adjustable to fit a wide array of people and situations. Further, there is a continued demand for harnesses that have a number of uses other than simply serving as a safety or rescue harness.

U.S. Pat. No. 8,056,675 (“675 Helms”) discloses a safety harness. For discussion purposes, FIG. 1 of 675 Helms is reproduced as FIG. 9 of this document, but the reference numerals have been redesignated and redrawn for clarity of discussion purposes. As shown in FIG. 9, harness 1100 of 675 Helms includes several separate pieces of webbing and/or other piece parts, including the following: rear arrest 1101; first webbing member 1102 (including first loop portion 1102a, back tether 1102b); carabineer member 1103; second webbing member 1111 (including right shoulder portion 1111a and left shoulder portion 1111b); third webbing member 1114; four webbing member 1115; and fifth webbing member 1150. Therefore, 675 Helms includes over five different pieces of webbing and also a carabineer.

At column 5, lines 5-25, 675 Helms discloses that rear arrest 1101 may be formed as a loop of strap material or a rigid loop, like a carabineer. While rear arrest 1101 is disclosed to be capable of being effectively formed from strap material, FIG. 1 of 675 Helms (and FIG. 9 of this document), it is clear that both rear arrest 1101a first webbing member 1102 are separate pieces from the second, third and fourth webbing members of 675 Helms. At column 5, lines 5-25, Helms effectively discloses that the first webbing member can rotate relative to the second and third webbing members to which it is mechanically connected (see DEFINITIONS section), but the first webbing member is not disclosed to be adjustable in length.

The following published documents may also include helpful background information: US design patent D602638 (“638 Dempsey”).

Description of the Related Art Section Disclaimer: To the extent that specific publications are discussed above in this Description of the Related Art Section, these discussions should not be taken as an admission that the discussed publications (for example, published patents) are prior art for patent law purposes. For example, some or all of the discussed publications may not be sufficiently early in time, may not reflect subject matter developed early enough in time and/or may not be sufficiently enabling so as to amount to prior art for patent law purposes. To the extent that specific publications are discussed above in this Description of the Related Art Section, they are all hereby incorporated by reference into this document in their respective entirety(ies).

### BRIEF SUMMARY OF THE INVENTION

In accordance with the foregoing objects and advantages, the present invention provides an adjustable multi-purpose tool comprising: (i) a multi-looped device formed from a single, continuous length of material, wherein the two ends of the length of material are affixed together, and wherein two smaller loops of the device form leg loops and a larger loop forms a torso loop. In some preferred embodiments, the adjustable multi-purpose tool comprises an adjustment ring (for example, a double buckle) and an adjustment loop (for example, a fabric loop) located near the top of the tool. The harness may include other loops and/or other structures for receiving and securing a rope or safety line.

Some preferred embodiments of the present invention are further sized, shaped, structured and/or connected so that the harness can be configured as a four limb harness and, alternatively, as a seat harness.

Various embodiments of the present invention may exhibit one or more of the following objects, features and/or advantages:

(i) a multi-purpose adjustable strap tool;

(ii) a single multi-purpose adjustable strap tool that can serve, for example, as a drag strap for humans and animals, a safety harness, and escape harness;

(iii) a multi-purpose adjustable strap tool that, when not in use, is substantially collapsible;

(iv) a support tool for supporting people suspended above the ground by ropes;

(v) a support tool for supporting animals suspended above the ground by ropes; and/or

(vi) a support tool for supporting objects suspended above the ground by ropes.

According to one aspect of the present invention, a harness tool includes: an elongated single piece web member; a first sewn structure; a second sewn structure; and a third sewn structure. The first sewn structure, the second sewn structure and the third sewn structure each mechanically connect portions of the web member together, with the first, second and third sewn structures being located so that two arm loops and two leg loops are formed in the single web member.

According to a further aspect of the present invention, a harness tool includes: a single elongated strip of web material; a plurality of sewn structures; and a double buckle. The plurality of sewn structures and the double buckle mechanically connect the strip of web material to itself to form: (i) a double ply behind the neck loop, (ii) a torso loop, (iii) two single ply arm loops, and (iv) two single ply leg loops. The double buckle is sized, shaped, located and/or connected so that the double buckle is slidably mechanically connected to the single piece of web material so that the relative sizes of the behind-the-neck loop and the arm loops may be adjusted by sliding the double buckle relative to the single piece of web material.

According to a further aspect of the present invention, there is a method of harnessing a body having two arms and two legs. The method includes the following steps (not necessarily in the recited order except as indicated): (i) providing a safety harness that includes two arm loops and two leg loops; (ii) inserting the body's legs respectively into the two leg loops; (iii) inserting the body's arms respectively into the two arm loops; and (iv) subsequent to the inserting-arms step, tying the excess portions of the two arm loops to each other in a knot so that the arm loops fit reliably and snugly around the arms of the body.

### BRIEF DESCRIPTION OF THE DRAWINGS

The present invention will be more fully understood and appreciated by reading the following Detailed Description in conjunction with the accompanying drawings, in which:

FIG. 1 is a perspective view of a first embodiment of an adjustable multi-purpose tool according to the present invention;

FIG. 2 is a perspective view of a portion of the first embodiment tool;

FIG. 3 is another perspective view of another portion of the first embodiment tool;

FIG. 4 is another perspective view of another portion of the first embodiment tool;

FIG. 5 is another perspective view of another portion of the first embodiment tool;

FIG. 6 is another perspective view of another portion of the first embodiment tool;

FIG. 7 is another perspective view of another portion of the first embodiment tool;

FIG. 8 is a perspective view of a second embodiment harness tool according to the present invention;

FIG. 9 is a perspective view of a prior art harness tool;

FIGS. 10A and 10B are schematic views of a third embodiment of a harness tool according to the present invention;

FIG. 11 is an adjustment ring structure suitable for use with harness systems according to the present invention, and which also may be novel in and of itself; and

FIGS. 12A to 12C show the first embodiment tool in a seat harness configuration.

### DETAILED DESCRIPTION OF THE INVENTION

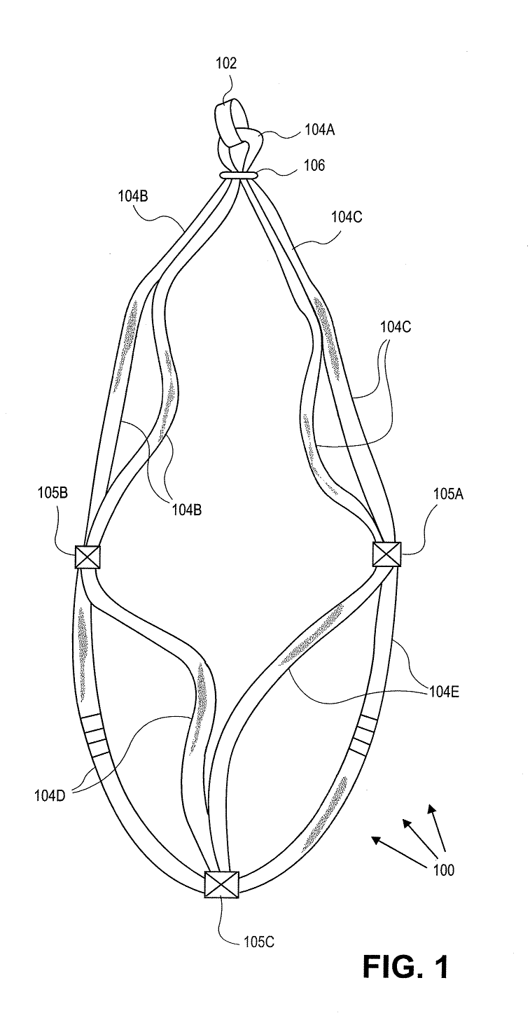

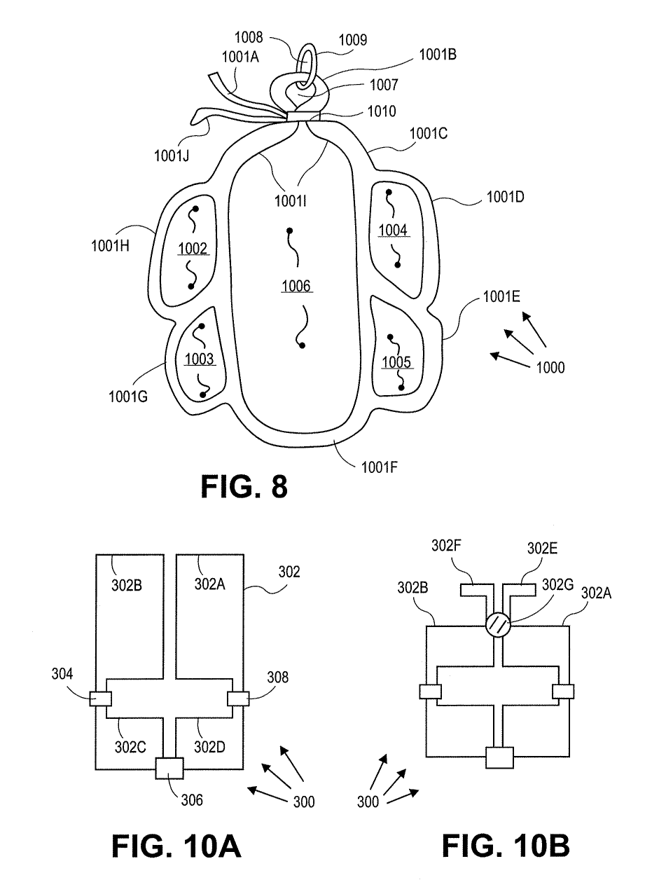

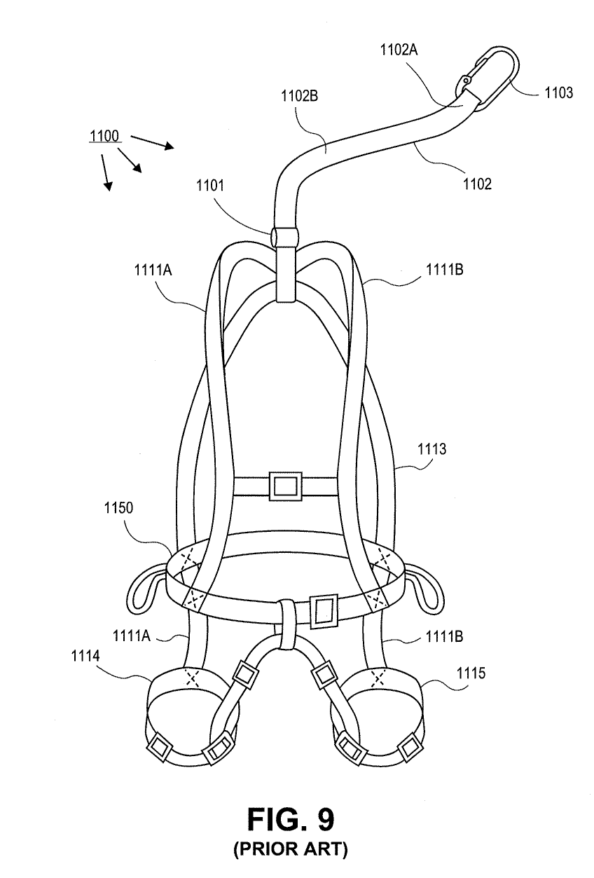

FIG. 8 shows harness tool 1000, including: web member 1001; fabric loop member 1009; and buckle type strap restraint structure 1010. The single web member includes the following portions: (i) first strap end 1001a; (ii) back-of-neck loop 1001b; (iii) left neck-to-shoulder 1001c; (iv) left arm loop 1001d; (v) left leg loop 1001e; (vi) left leg loop 1001e; (vii) torso loop 1001f; (vii) right leg loop 1001g; (viii) right arm loop 1001h; (x) right neck-to-shoulder 1001i and (x) second strap end 1001h. As shown in FIG. 8, a single web member forms six (6) loops as follows: (i) back-of-the-neck loop 1007; (ii) torso loop 1006; (right arm loop 1004; (iii) right leg loop 1005; (iv) right arm loop 1004; (v) left leg loop 1003; and right arm loop 1002. It is noted that there may be additional loops formed from the single web member 1001. It is noted that additional web members may be present, to form additional loops, provide additional kinds of support and so on. It is noted that the strap ends of the web member adjustably engage with buckle 1010 so that the relative sizes of torso loop 1006, the back-of-the-neck loop 1007, the neck-to-shoulder portions 1001c, 1001i and the hanging straps 1001a, 1001j. This adjustability allows the harness to be comfortably and securely used with people and animals of different sizes. In this embodiment, the single piece web member is not sewn to itself, but many embodiments of the present invention form the arm and/or leg loops by sewing a strip shaped web member to itself at certain predetermined points, as will be seen in the discussion of FIGS. 1 to 7 below.

FIGS. 1-7 show a harness tool system 100 including: line engaging fabric loop 102; single piece of web material 104; sewn structures 105a,b,c; double buckle 106 (including first aperture 106a and second aperture 106b); and human user 150. The single piece web includes: behind-the-neck loop portion 104a; right arm loop portion 104b; right leg loop portion 104d; left arm loop portion 104c; and left leg loop portion 104e.

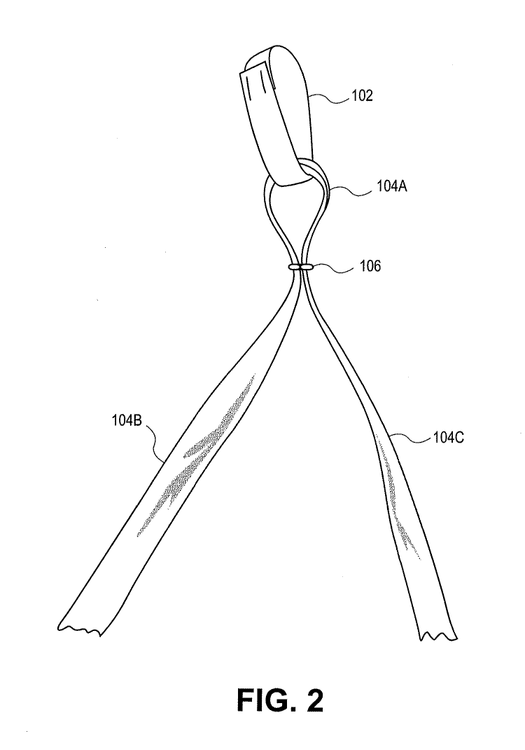

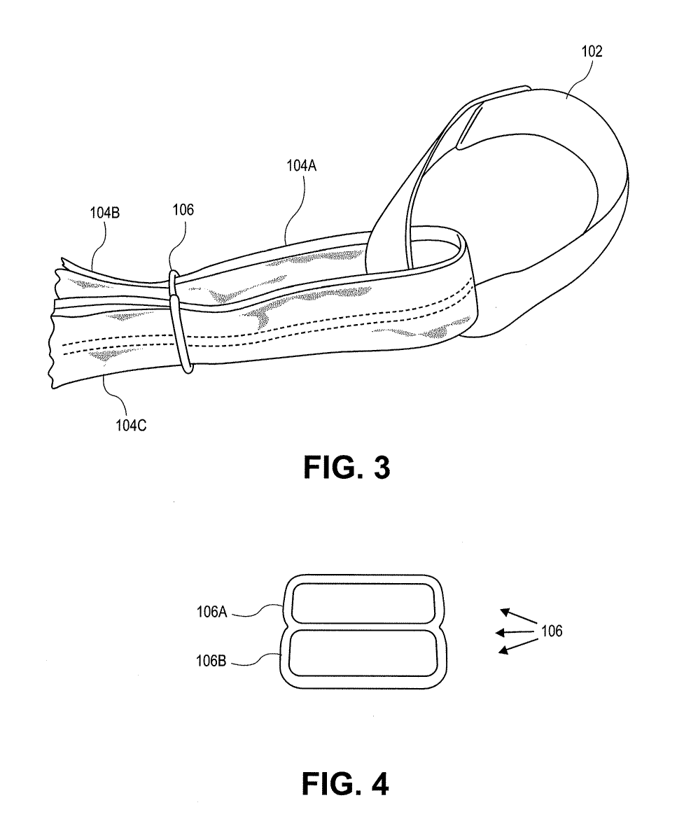

As shown in FIGS. 2 to 4, a single piece of webbing is used to form the behind the torso loop, the behind-the-neck loop (double ply thick), the two arm loops (single ply thick) and the two leg loops (single ply thick). To make harness 100 the following steps are performed (in any order feasible): (i) fold web member in half longitudinally (so that it is about ten feet long instead of the original 20 feet long) to form a double ply web member; (ii) thread the folded web member through fabric loop 102; (iii) weave the double ply web member through the double buckle 106 as shown in FIGS. 2 and 3 so that the buckle is located halfway along the length of the folded web member, forms double ply behind-the-neck loop 104a that captures fabric loop 102 by chain-and-link engagement; (iv) make stitching structures 105a,b,c (see FIG. 1) to form single ply arm loops 104b, c and leg loops 104d, 104e; and (v) slide double buckle 106 to adjust the size of the behind-the-neck loop, the arm loops and/or the torso loop.

In tool system 100, the durable, single-piece webbing 104 forming the bulk of the adjustable multi-purpose tool is approximately 20 feet, 6 inches long before it is sewn together at its attachment points to make the arm and leg loops. After the two ends are sewn together and the device is held in the air, the tool is approximately 5 feet long (as shown in FIG. 1, stitching 105a,b,c for example). In a preferred embodiment, the webbing is 1 inch tubular webbing, although any webbing sufficiently durable and/or strong to perform the required functions is suitable. This can include nylon or any other material known to one skilled in the art. Alternatively, the webbing can be any length that satisfies the requirements of the user. For example, the webbing may be substantially shorter if the tool will be used to fit a small child.

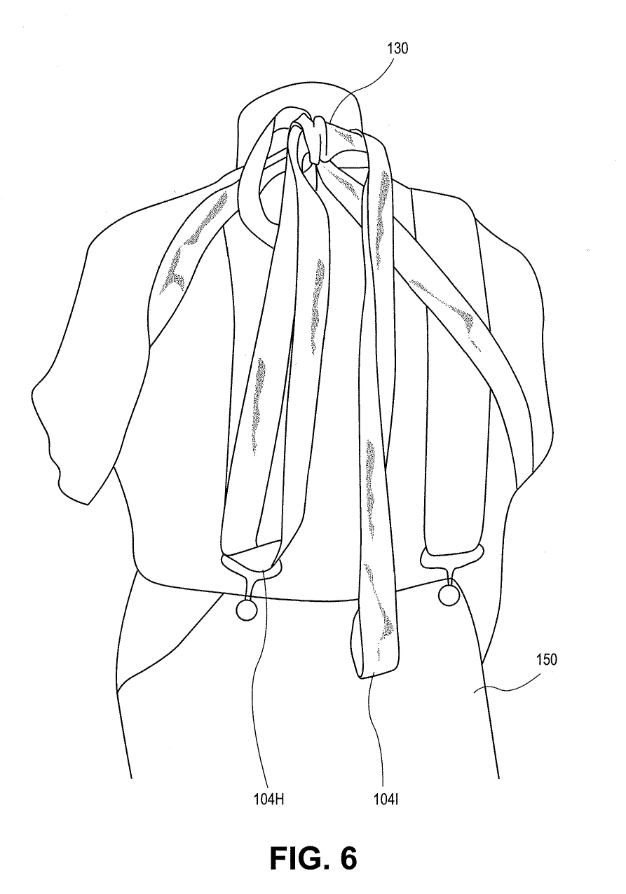

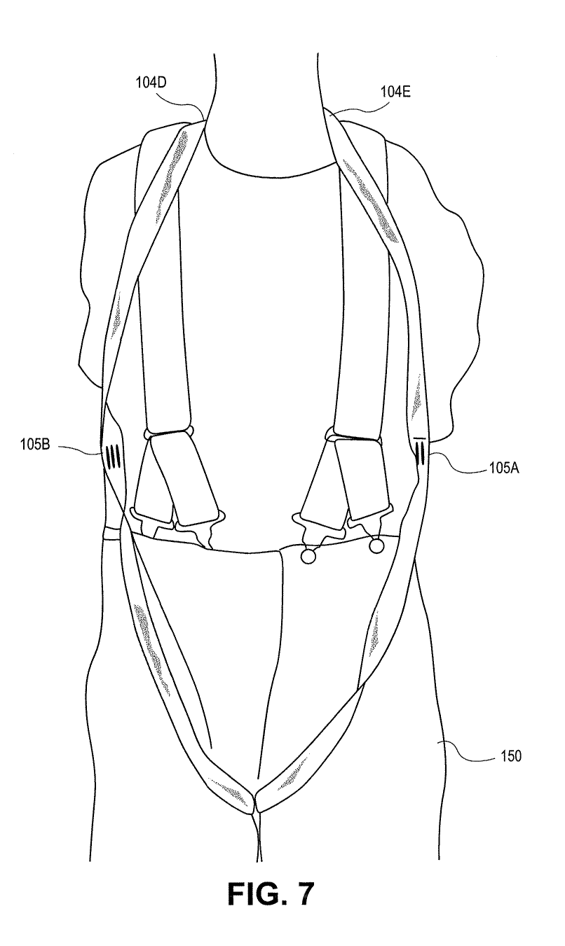

To form the adjustable multi-purpose tool, the two ends of the webbing are sewn or otherwise fixed together—either permanently or removably, depending on the requirements of the user and the function(s) for which it will be employed—to form a single, continuous loop of webbing of approximately 10 feet long (or approximately 50% of the full length of the un-sewn webbing) when the loop is held in the air. This long 10 foot length of web material is used to make the torso loop, as well as the arm loops, leg loops and the behind-the-neck loop as will be explained in detail below. Next, the initial, large loop is sewn in three locations, 105a,b,c, to form the two arm loops 104b, 104c and two leg loops 104d, 104f. The leg loops extend from the bottom of the torso loop 105c, preferably up to between one-third and one-half of the way up the length of the torso loop as shown in FIG. 1. The leg loops are sized to accommodate the legs of a user, as shown in FIGS. 5 and 7. In an alternative embodiment, the two ends of the original length of webbing can be sewn together at any of the three loop-creating sewing sites. This avoids the creation of a fourth conjunction point for the webbing. Indeed, the use of a single length of webbing makes the adjustable multi-purpose tool exceptionally strong and durable. Also, as stated above, the term “sewn” means to sew using thread, as well as any other method connecting material known to one skilled in the art for mechanically connecting a web member to itself, including but not limited to rivets, stapling and gluing.

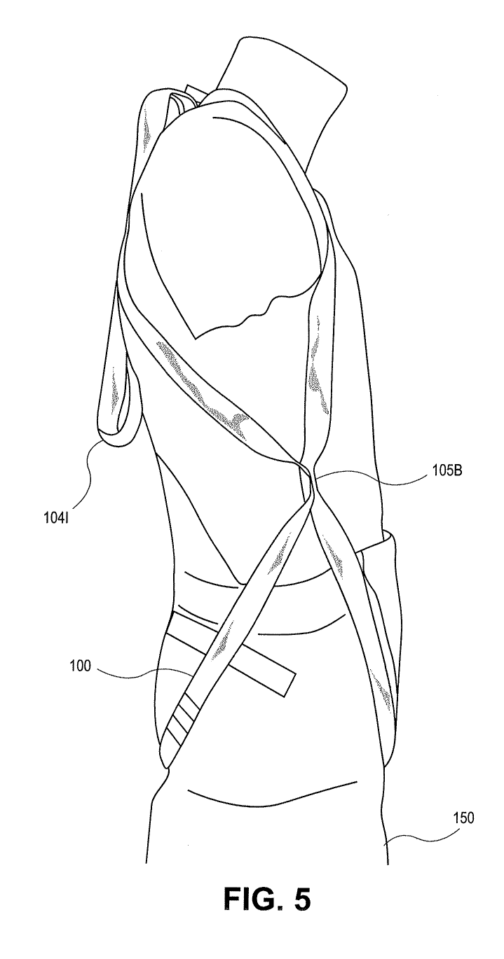

The adjustable multi-purpose tool also preferably comprises a two aperture adjustment ring (sometimes herein called a “double buckle”), shown alone in FIG. 4 and on the tool in FIGS. 2 and 3. The adjustment ring, which can be metal, plastic, or any other sufficiently strong material. The double buckle separates the behind-the-neck loop from the torso loop. By sliding the double buckle and the web member relative to each other, the relative sizes of the torso loop, the arms loops and the behind-the-neck loop to be adjusted relative to each other, for a snug, comfortable secure fit. For example, FIGS. 5 and 6 shows the adjustment ring pulled downward on the tool, thereby more accurately fitting the mannequin and creating an excessively large behind-the-neck loop which can be tied off to keep the accurate fit (as best shown in FIG. 6). The ring easily slides up and down the double ply web member strap to allow for quick and efficient adjustment. As a result, it easily fits any individual, regardless of size.

As shown in each of the figures, the adjustable multi-purpose tool preferably comprises line engaging fabric loop 102. The primary purpose of fabric loop 102 is to be threaded around a safety line so that the harness (and the worker in the harness) will be secured to the safety line at all times and cannot fall any great distance. The fabric loop also makes it easier to adjust the tool, since this can be pulled away from the double buckle with one hand while the other hand pushes or pulls the adjustment ring up or down the loop. This is especially true if the user is wearing gloves, which often make fine adjustments difficult. More particularly, by pulling all both plies of the double buckle taut and perpendicular to the major surfaces of the double buckle with the fabric loop as a sort of handle, it becomes easy to slide the double buckle relative to the taut web member in order to make loop size adjustments.

One advantage of the adjustable multi-purpose tool is that it can be folded or otherwise compacted to fit within a small space such as a rescue bag, or a pocket.

As will be recognized by one skilled in the art, the adjustable multi-purpose tool serves numerous functions, including but not limited to home, recovery, fire safety, military, and hunting purposes. The adjustable multi-purpose tool serves numerous functions in part because it is easily adjustable and adaptable to any situation. As a result, the tool is instantly ready to serve as a harness, drag, or utility strap. In light of the comfort of the adjustable multi-purpose tool when it is used as a harness, it can be worn all day while working. It can also be used, for example, as a safety harness, a fast rescue harness, as a drag strap for a downed victim of any number of emergencies, as animal drag when hunting, or as a carrying strap for tools.

To use the adjustable multi-purpose tool as a harness, for example, the user (or a rescuer who performs these actions for a victim) puts his/her legs in the two leg loops and pulls the tool upward such that the bottom connection point, shown in the bottom of FIG. 5, rests approximately in the crotch region of the user, as shown in FIG. 7. When in this position, the two side connection points will be approximately on the left and right sides of the user, as shown in FIGS. 6 and 7. The top of the tool is placed behind the head and the adjustment ring and/or adjustment loop is used to make the torso loop smaller, thereby tightening the harness onto the user and forming a fitting four-point harness (crotch, left side, right side, and neck), as shown in FIGS. 5-7.

While embodiment 100 of the present invention, discussed above, includes a double buckle, some preferred embodiments of the present invention omit the double buckle as will now be discussed in connection with harness tool 300 of FIGS. 10A and 10B. FIGS. 10A and 10B show two somewhat schematic views of harness 300, including: single web member 302; first sewn structure 304; second sewn structure 306 and third sewn structure 308. In FIG. 10A, the harness is in the open configuration. In FIG. 10B, the harness is in its secured configuration, as it would be after it had been used to harness a body (body not shown in FIG. 10B). More particularly, in FIG. 10A, the sewn structures cause two arm loops 302a,b and two leg loops 302c, d to form in the single web member. After the body's arms and legs are inserted into the appropriate arm and leg loops, the excess portion of the two arm loops are tied together (for example, by an overhand knot) in order to: (i) decrease the size of the m loops so that they fit snugly around the arms and shoulders of the harnessed body; (ii) form knot 302g (see FIG. 10B); and (iii) form knot end terminal loops 302f,g (see FIG. 10B). In this preferred embodiment, the double buckle is omitted.

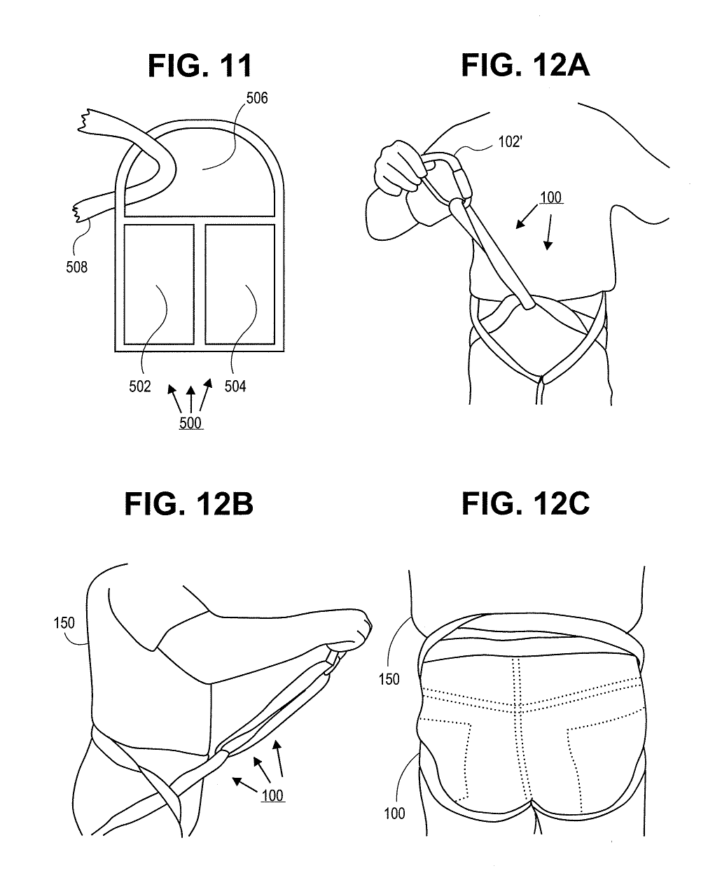

FIG. 11 shows a variation on the double buckle in the form of adjustable ring structure 500 including: first strap(s) aperture 502; second strap(s) aperture 504; curved loop 506; and carabineer 508. Structure 500 is similar to double buckle 130, discussed above, except for the addition of curved loop 506. Curved loop 506 secures carbineer 508, or a rope or otter similar anchoring structures by chain-and-link engagement. Structure 500 I considered to be preferred and inventive because it can decrease the number of piece parts, and can also make sure that weight of a hanging body (for example, a body being rescued) is well supported and well distributed for stable carrying without damage to the equipment or any carried bodies. It is noted that carabineer engaging loops, rope engaging loops or the like can be attached anywhere on the harness tool that will lead to loads being carried in a stable, balanced and well distributed manner.

FIGS. 12A, 12B and 12C show how tool 100, discussed above, can also be configured to fit on user 150 as a seat harness which holds the user only at his hips. As shown in these figures, the leg loops are fitted around the legs in the same manner as discussed above in connection with the four point configuration of FIGS. 1 to 7. The torso loop is also fitted around the torso so that the double buckle is behind the user, again similar to the four point configuration. However, the buckle is positioned behind the lower back (see FIG. 12C), rather than behind the neck as in the four point configuration. Also, as shown in FIGS. 12A and 12B, the “neck loop” portion is looped around the users waist to form the “seat” that cradles the user's buttocks (see FIG. 12C). This additional configuration makes the present invention more robust, and suited for a wider variety of harness system applications. It is also noted that in FIGS. 12A to 12C, the fabric loop 102 has been replaced by carabineer 102′.

Although the present invention has been described in connection with a preferred embodiment, it should be understood that modifications, alterations, and additions can be made to the invention without departing from the scope of the invention as defined by the claims.

### DEFINITIONS

Any and all published documents mentioned herein shall be considered to be incorporated by reference, in their respective entireties. The following definitions are provided for claim construction purposes:

Present invention: means “at least some embodiments of the present invention,” and the use of the term “present invention” in connection with some feature described herein shall not mean that all claimed embodiments (see DEFINITIONS section) include the referenced feature(s).

Embodiment: a machine, manufacture, system, method, process and/or composition that may (not must) be within the scope of a present or future patent claim of this patent document; often, an “embodiment” will be within the scope of at least some of the originally filed claims and will also end up being within the scope of at least some of the claims as issued (after the claims have been developed through the process of patent prosecution), but this is not necessarily always the case; for example, an “embodiment” might be covered by neither the originally filed claims, nor the claims as issued, despite the description of the “embodiment” as an “embodiment.”

First, second, third, etc. (“ordinals”): Unless otherwise noted, ordinals only serve to distinguish or identify (e.g., various members of a group); the mere use of ordinals shall not be taken to necessarily imply order (for example, time order, space order).

Mechanically connected: Includes both direct mechanical connections, and indirect mechanical connections made through intermediate components; includes rigid mechanical connections as well as mechanical connection that allows for relative motion between the mechanically connected components; includes, but is not limited, to welded connections, solder connections, connections by fasteners (for example, nails, bolts, screws, nuts, hook-and-loop fasteners, knots, rivets, quick-release connections, latches and/or magnetic connections), force fit connections, friction fit connections, connections secured by engagement caused by gravitational forces, pivoting or rotatable connections, and/or slidable mechanical connections.

double buckle: may include more than two apertures; may or may not have two apertures arranged in the general shape of a FIG. 8 (see FIG. 4).

Unless otherwise explicitly provided in the claim language, steps in method or process claims need only be performed that they happen to be set forth in the claim only to the extent that impossibility or extreme feasibility problems dictate that the recited step order be used. This broad interpretation with respect to step order is to be used regardless of alternative time ordering (that is, time ordering of the claimed steps that is different than the order of recitation in the claim) is particularly mentioned or discussed in this document. Any step order discussed in the above specification, and/or based upon order of step recitation in a claim, shall be considered as required by a method claim only if: (i) the step order is explicitly set forth in the words of the method claim itself; and/or (ii) it would be substantially impossible to perform the method in a different order. Unless otherwise specified in the method claims themselves, steps may be performed simultaneously or in any sort of temporally overlapping manner. Also, when any sort of time ordering is explicitly set forth in a method claim, the time ordering claim language shall not be taken as an implicit limitation on whether claimed steps are immediately consecutive in time, or as an implicit limitation against intervening steps.

What is claimed is:

1. A harness tool comprising:
An elongated single piece web member;
a first sewn structure;
a second sewn structure; and
a third sewn structure;
wherein:
the first sewn structure, the second sewn structure and the third sewn structure each mechanically connect portions of the web member together, with the first, second and third sewn structures being located so that two arm loops and two leg loops are formed in the single web member.

2. The tool of claim 1 wherein the single piece web member is shaped as a substantially uniform width strip.

3. The tool of claim 1 wherein the two arm loops are sized so that the two arm loops can be tied together at their respective ends.

4. The tool of claim 1 further comprising a double buckle slidably engaged with the two arm loop portions of the single web member.

5. The tool of claim 4 further comprising a harness-tightening loop located so that the two arm loop portions of the single web member pass through the fabric loop.

6. A harness tool comprising:
a single elongated strip of web material;
a plurality of sewn structures; and
a double buckle;
wherein:
the plurality of sewn structures and the double buckle mechanically connect the strip of web material to itself to form: (i) a double ply behind the neck loop, (ii) a torso loop, (iii) two single ply arm loops, and (iv) two single ply leg loops; and
the double buckle is sized, shaped, located and/or connected so that the double buckle is slidably mechanically connected to the single piece of web material so that the relative sizes of the behind-the-neck loop and the arm loops may be adjusted by sliding the double buckle relative to the single piece of web material.

7. A method of harnessing a body having two arms and two legs, the method comprising the steps of:
providing a safety harness that includes two arm loops and two leg loops;
inserting the body's legs respectively into the two leg loops;
inserting the body's arms respectively into the two arm loops; and
subsequent to the inserting-arms step, tying the excess portions of the two arm loops to each other in a knot so that the arm loops fit reliably and snugly around the arms of the body.
